(19) United States
(12) Patent Application Publication
(10) Pub. No.: US 2017/0157547 A1
(43) Pub. Date: Jun. 8, 2017

(54) AN AIR CONDITIONING FILTER CLEANER AND FILTER CLEANING SYSTEM

(71) Applicant: AIRVAC LIMITED, Cheam Surrey (GB)

(72) Inventor: Robert Anthony PAYNE, Banstead Surrey (GB)

(21) Appl. No.: 15/325,552

(22) PCT Filed: Jul. 14, 2015
(86) PCT No.: PCT/IB2015/055321

§ 371 Date: Jan. 11, 2017

(30) Foreign Application Priority Data
Jul. 14, 2014 (GB) 1412453.1

(51) Int. Cl. B01D 46/00; B01D 46/10; F24F 13/10; F24F 3/16; F24F 13/28

(52) U.S. Cl. CPC B01D 46/0065; F24F 3/1603; F24F 13/28; F24F 13/10; B01D 46/10; B01D 46/0075; B01D 46/0068; F24F 2003/1639; B01D 2273/28

(57) ABSTRACT

An air conditioning filter cleaner for use with an air conditioning system of multiple units. The filter cleaner comprises a brush configured to clean dust from an air filter. The brush is in moving contact with the air filter and driven by a motor. A conduit is connected between the brush and a vacuum source that provides a suction force through the conduit to the brush. The conduit is remotely opened and closed by way of a solenoid or remotely controlled valve. A system controller oversees filter cleaners each connected to a network of ducts, each filter cleaner has an associated valve which opens a duct to which the filter cleaner is connected. A control system selectively actuates the filter cleaner and actuates the associated valve so that dust from the filter is removed to a remote dust collector. Optionally a HEPA filter is provided at a remote collection location.

### FIELD OF THE INVENTION

The present invention relates to an air conditioning filter cleaner and filter cleaning system.

### BACKGROUND

Air conditioning systems are common in many buildings and in particular in offices. These air conditioning systems generally comprise ducting located above a false ceiling or behind a false wall. Ducting leads to an exit grating or exit terminal in an office, corridor or meeting room. Air is pumped around the ducting from a central source. The air is either heated or cooled depending on the ambient external/internal environment and the requirements of the building occupants.

In order to provide cool air to a building, a stream of air is cooled by passing the stream over an evaporator coil in order to extract heat therefrom. Each air conditioning system is fitted with at least one, and generally a number of filters, located upstream of the evaporator coil. These remove particles of dust and fibres from the air stream to keep the air conditioning system clean and to clean the air by removing particles from it.

Air conditioning units such as those fitted in office buildings have required regular cleaning of their filters, without which they become clogged. Where there is clogging, there is an increased resistance to the movement of air, which is caused by the build-up of dust, and this resistance places additional load on fans and motors. Consequently efficiency is lowered and there is a greater consumption of electricity. This wastes resources and is expensive.

To clean some types of air conditioning systems there is often a need for specialist maintenance engineers to be present in order to gain access to air conditioning system and in particular the filter. As cleaning personnel require access to the filters, which may also be located in ducting, there is often a need for them to enter offices and rooms. If this work is carried out during work hours, this causes disruption to a routine of occupants in the offices.

If cleaning is performed outside normal working hours, then the maintenance personnel are may need to be paid more. There may also be a need for supervision of maintenance staff in some offices and a need for additional security staff in order to oversee access outside normal office working hours.

In addition, as with many types of routine maintenance, there is a need to gain access to, clean and sometimes replace multiple filters and undertake such routine maintenance tasks repetitively. Consequently there is not only disruption caused in multiple spaces, but such tasks are labour intensive, times consuming and require specialist teams of heating engineers.

The invention seeks to overcome the aforementioned problems by providing an automatic cleaning system which is operable remotely.

A further aim of the invention is to provide a remotely operated dust and particulate retrieval and collection system which may be operated remotely.

### Prior Art

Japanese Patent Application JP-A-2011156310 (Mitsubishi Electric Building Tehno Service Co) describes and shows a vacuum cleaning brush for an air filter that has a brush head which is connected to a vacuum suction device and has a suction opening with a width which is several times that of the pitch of the folds in the filter. A plurality of the brushes is set around the suction opening which are capable of moving in a direction perpendicular to the suction opening.

Korean Patent Application KR-A-100912658 (Taeha Engineering Architects Co Ltd) describes air-conditioning unit having a drying filter cleaning function that comprises a pair of first guide rods, a contaminant suction nozzle, a first power transmission member, an elevation position restriction sensor and a switch signal input unit. The first guide rod is installed in the front both sides of an air filter. The contaminant suction nozzle is installed between the first guide rods.

UK Patent Application GB-A-2457116 (LG Electronics Inc) describes an air conditioning system for location in a ceiling which includes an air suction hole through which air is sucked and passes through a filter. A brush assembly comprising a brush contacts the filter to collect and store foreign matter and dust that has dropped from the filter under gravity. A plurality of rollers move the brush assembly.

Japanese Patent Application JP-A-20070322 (Matsushita Electrical Industrial Company Limited) discloses a dust removing device whose output includes a driveable belt having a small suction hole on its nozzle. This limits suction to the suction area which is immediately proximal to the brush. An air filter is closed by carrying out a sweep action on the air filter along with a suction nozzle.

Japanese Patent Application JP20080110 (Toshiba Carrier KK) describes a cleaning unit with a dust reservoir that holds brushes and is used for removing dust adhering to an air conditioning filter. A dust discharge unit has a ventilation fan and an exhaust duct which sucks dust stored by the cleaning unit. An adjoining connection to a cleaning unit enables dust discharge outdoors through a dust discharging unit.

Korean Patent Application KR-A-20090217 (Gonggan Tech Company limited) describes an apparatus which has a vacuum cleaner which is housed inside an air conditioning unit. The apparatus is equipped with a fan. Connected to the fan is a motor. Air is drawn by suction across a grill and a filter which is mounted in the grill for filtering dust and debris from the air.

A vertical moving means is connected to a brush for moving and displacing the brush across the filter so as to clean foreign matter and dust into a coupling hose connected to the brush.

International Patent Application WO-A-2004/079271 (Matsushita Electric Industries) describes an air conditioning system having a heat exchanger and a fan which blows air across the heat exchanger and an air filter which is provided on the body upstream of the heat exchanger. A nozzle has a suction port facing the air filter and extracts dust and dirt attached to the air filter. The cleaning head is slidably fitted with the suction nozzle and exhausts dirt therefrom.

European Patent Application EP-A-1959211 (Daikin Industries ltd) describes a ceiling-mounted air conditioning apparatus with an integral cleaner, comprising a casing in which an intake port is formed in a bottom surface. A filter is provided in an intake port. A cleaning mechanism removes dust collected by the filter from the filter and a dust box is provided at the bottom of the casing to collect dust removed by the cleaning mechanism. A nozzle insertion hole, through which a nozzle of a vacuum cleaner can be inserted, is formed facing downward in the dust box.

In contrast the present invention provides a simple and reliable apparatus for cleaning the filters of air conditioning units and multiple filters of an air conditioning system which can be operated automatically and remotely.

### SUMMARY OF THE INVENTION

According to a first aspect of the present invention there is provided an air conditioning filter cleaner comprising: a brush; a drive means which is connected to the brush and which moves the brush with respect to the air filter so as to remove dust and debris from the air filter; a conduit collects dust removed by the brush; and a remote vacuum source provides a suction force through the conduit to the brush, characterised in that the conduit provides a path for dust passing from the brush to a remote location where dust is collected and at least one remotely operable valve is provided between the location where dust is collected and the brush, the valve being selectively switchable to open and close a pathway in the conduit from a selected filter cleaner to the remote location where dust is collected.

The invention enables an operator, or an automatic controller, to be able to switch on a specific cleaner, open one or more valves in network of conduit from a remote pump or fan, to the selected cleaner and initiate cleaning of a selected air conditioning filter, so that debris and dust is removed without any intervention or access. The debris and dust that is removed from the filter is sucked away via the network of conduit to a remote collection means or tank.

Preferably a vacuum head is provided on each air conditioning filter cleaner and the vacuum head has a gate, shuttle or solenoid valve to allow pressure to be maintained during the cleaning operation of the air conditioning filter or filters.

Sensors may be provided on a vacuum head in order to monitor amount of dust and debris that is present or the state of a filter before and after cleaning. A sensor may include a light source and a photocell arranged to transmit a signal indicative of the amount of dust present on the filter or when the amount of dust or debris present on a filter exceeds a predefined threshold, thereby automatically initiating cleaning of a filter or altering an operator to the need to clean a specific filter.

The remote location may have one or more vacuum sources, such as pumps, fans, blowers or exhausters in case of failure or the need to repair one of the pumps, fans blowers or exhausters.

It is appreciated that the system is scalable to allow a single vacuum source to operate and clean multiple filters by way of a network of selectively switchable air ducts and conduits. The system allows independent control of multiple filter cleaners according to one or more different factors, such as a sensed pressure drop and/or a planned time interval and/or a sensed parameter and/or independent control.

Brushes may have a deformable means which may include a wiper and/or a scraper and/or a rubber member or other form of bristles to assist in dislodging dust and debris. Optionally a moveable shutter closes an air conditioner vent during cleaning. The shutter may be controlled remotely to close prior to cleaning and to open after cleaning has finished.

Preferably the deformable means has a resilient means that displaces and removes debris or dust wherein a conduit is configured at or adjacent the vacuum head so as to receive substantially all dislodged debris and dust.

The combination of the brush and a partial vacuum drawing air through the conduit ensures that debris that is cleaned from the filter is immediately removed from the filter thereby preventing the dust from spreading.

The air filter cleaner may further comprise a clamping means configured to connect the air filter cleaner to a filter housing. This helps to ensure the air filter cleaner can be retrofitted air filters of already installed air conditioning units, such as those already installed in a building.

The clamping means may have a front fascia that extends and overlaps with an air filter when connected to the filter housing. This helps to ensure the air filter cleaner can be retrofitted to an already installed air filter. The fascia may form a surrounding frame for the air filter.

The drive means ideally comprises an electric motor, the brush sized and aligned to pass across an air filter and driven by the motor along the filter in a direction substantially perpendicular to the axis across the filter. This provides a simple and effective configuration for cleaning.

The conduit which interconnects air conditioning cleaners may be elastically extendable or it may be formed from rigid ducts. The diameter of the ducts may vary from a relatively large diameter, typically greater than 0.25m in diameter, close to a pump or fan, to a relatively smaller diameter, typically less than 0.1m, close to an air conditioner filter cleaner. In one embodiment the ducting at the air conditioner filter cleaner is flexible and this helps to ensure the conduit to move with the brush across the filter. In an alternative embodiment the conduit may be telescopic when it connects to the brush.

Ideally the conduit is aligned with the direction of movement of the brush so that it extends and retracts as the brush moves. This helps to ensure the conduit moves with the brush across the filter and avoids the conduit blocking the filter in use.

The conduit is ideally positioned at or towards one edge of the filter in use. This helps to ensure the conduit moves with the brush across the filter and avoids the conduit blocking the filter in use.

An outer end of the conduit, remote from the brush may be configured for connection to a suction hose or similar. This helps to ensure the air filter cleaner can be retrofitted to an air filter in a building.

In one embodiment a T-piece, ‘swept T’ or branch junction connection is provided which enables side branches to extend from a main network in order to provide additional local suction, for example for cleaning personnel to use bespoke cleaning equipment for floors and dusting.

The brush may further comprise a vacuum body located adjacent to the brush. This helps to hold the brush in the required orientation and location, and to contain dust removed from the filter by the brush.

According to a second aspect of the present invention there is provided an air conditioning system comprising: at least one duct configured for locating in a building to transport conditioned air within the building; at least one filter associated with the duct, aligned across the duct and configured to filter air passing along the duct, and; at least one air filter cleaner as herein described associated with the air filter. This allows the system to be fitted to a building in use and filters to be cleaned automatically and remotely.

The air conditioning system may comprise a plurality of ducts and/or associated filters and/or filter cleaners arranged as part of a system. The filter cleaners are fluidically connected via hoses to a remote dust collector. The system further comprises a central vacuum system configured to provide a suction force to individual filters which are selectively switched on by activating valves using electrically controlled servo devices or solenoid valves.

A plurality of solenoid valves are located throughout a network of hoses and are selectively activated to close or open pathways within the hoses to direct suction force to one or more of the filter cleaners. This allows the air filter cleaners to be selectively or sequentially activated to help direct a vacuum with the necessary force to clean an individual filter.

The air conditioning system may further comprise a central collection unit. This allows the dust to be centrally collected and disposed of easily.

Advantageously the air conditioning filter cleaner includes a filter closing means configured to enclose the filter to prevent dust from back flowing into a room or office when the cleaning system is activated. Optionally a vibration means is configured to connect with the filter to vibrate the filter, so that dislodged dust and particles are dislodged and withdrawn via the conduit that is connected to a vacuum source so as to provide at least one path for dust passing from the filter to a remote location.

Alternatively a pressured source of air, for example in the form of a narrow ‘pencil’ of air or ‘blade’ of air, which is directed to a reverse face of the filter, may be used to dislodge dust. This provides a simple, reliable and effective means for cleaning air filters as the vibrating means or pressurised pulse of air helps to dislodge dust and debris.

The air conditioning filter cleaner may further comprise a clamping means configured to connect the air filter cleaner to filter housing. This helps to ensure the air filter cleaner can be retrofitted to an air filter in a building.

The clamping means may be a front fascia that extends and overlaps with an air filter when connected to the filter housing. This helps to ensure the air filter cleaner can be retrofitted to an air filter in a building.

A vibrating means may comprise a cam or flap configured to rotate to cause the filter to vibrate. This provides a reliable and effective mechanism for causing vibration so helping to dislodge debris and dust and assist in its collection

A filter closing means may be at least one moveable shutter. This provides a reliable and effective mechanism.

Preferred embodiments of the invention will now be described by way of example only and with reference to the Figures in which:

### BRIEF DESCRIPTION OF FIGURES

FIG. 1 shows a perspective view from the front and to one side of an embodiment of an air conditioning filter cleaner;

FIG. 2 shows an exploded view of the air conditioning filter cleaner of FIG. 1 from generally the same angle;

FIGS. 3a, 3b and 3c show the air conditioning filter cleaner of FIGS. 1 and 2 connected to an air filter housing in operation moving across the filter to clean the filter;

FIG. 4a shows a perspective view from above and to one side of a housing and duct which optionally surrounds an air conditioning unit on which the air filter cleaner is fitted;

FIG. 4b shows an exploded view from the same angle as FIG. 4a of the housing;

FIG. 5 shows an overall diagrammatical view of an alternative embodiment of an air conditioning filter cleaner located in front of an air conditioning unit;

FIG. 6a is a diagrammatical view of a network of air conditioning filter cleaning units interconnected by way of air ducts;

FIG. 6b is a plan view of a ground floor of a building showing where air conditioning units are located and are interconnected with concealed air ducts and corresponds to FIG. 6a;

FIG. 7a shows a plan view of a first floor of a building of interconnected cleaning units and also shows separate conduits for vacuum cleaners;

FIG. 7b is an overall diagrammatical view of a first floor of a building which corresponds to FIG. 7a;

FIG. 8 is a front elevation view of a building in which air conditioning units, air conditioning filter cleaners and air conditioning ducting is installed;

FIG. 9a shows an overall diagrammatic view of an alternative embodiment of an air conditioning filter cleaner with a retractable duct having a telescopic conduit;

FIG. 9b shows an alternative embodiment of an air conditioning filter cleaner having a circular front panel filter which is arranged to rotate with respect to a cleaning element;

FIG. 9c is a side sectional view of the embodiment shown in FIG. 9b; and

FIG. 9c shows a side elevation view of a telescopic duct with a cleaning head which corresponds to the embodiment shown in FIG. 9b.

### DETAILED DESCRIPTION OF FIGURES

Embodiments of the air conditioning filter cleaner of the present invention will now be described with reference to the figures.

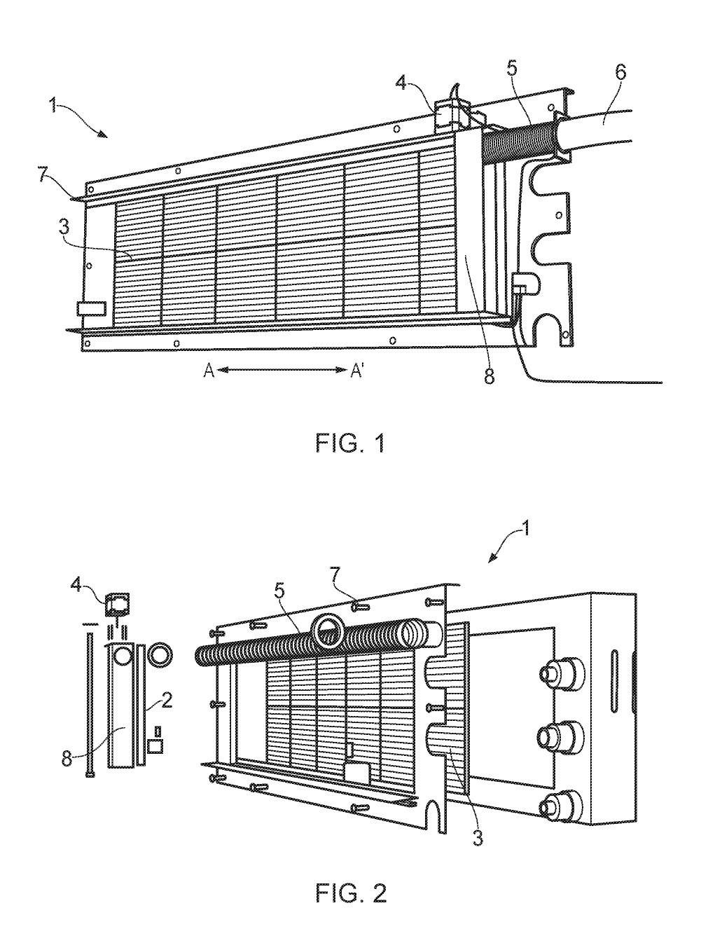

A first embodiment of the filter cleaner is shown in FIGS. 1 to 3. The filter cleaner 1 has a front fascia 7 that forms a hollow-centred frame which attaches to a front of a housing for an air filter 3, so that the perimeter of the hollow centre of the fascia 7 surrounds the air filter 3, generally in alignment with the perimeter of the air filter 3. This feature enables the air filter cleaner 1 to be retrofitted onto existing air conditioning units.

A brush 2 is connected to the front or outer side (away from the air filter 3) of the front fascia 7. The brush 2 is dimensioned and aligned so that it passes across the entire width or height of the open part of the air filter 3. The brush 2 is connected to the front fascia 7 via a vacuum body 8 that forms a housing for the brush 2. The housing of the vacuum body 8 connects the brush 2 to the front fascia 7 so that the vacuum body 8 is able to move from side-to-side, in direction of arrow A-A′ across the full width of the front fascia 7.

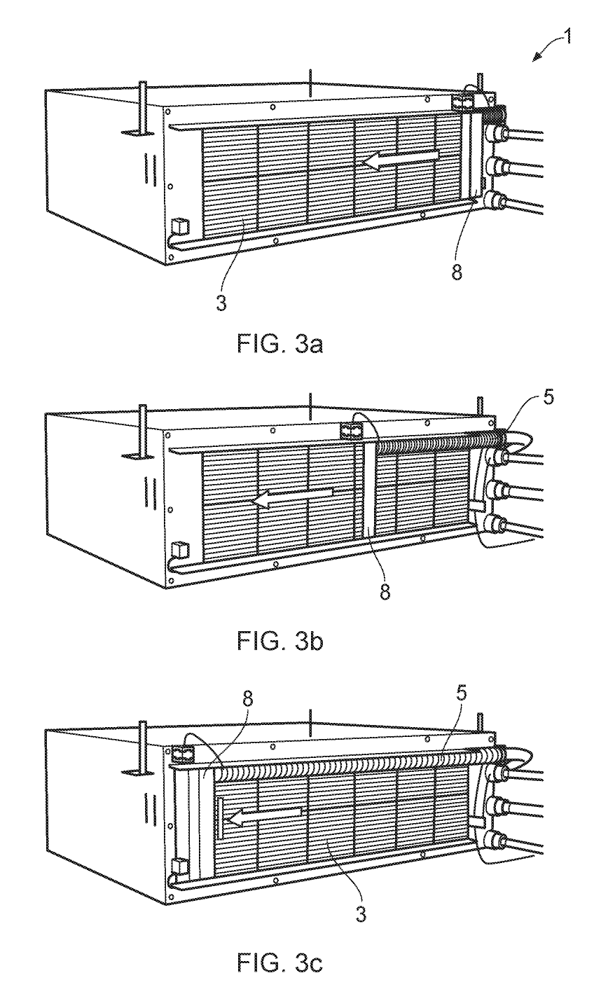

This sideways movement of the vacuum body 8 ensures that the filter 3, as shown in FIG. 3, is thoroughly brushed and dirt and dust is dislodged therefrom. The brush 2 is held close to the filter 3 surface to ensure dust is dislodged. This is achieved by way of the drive means 4 and mountings, such as rails (not shown) which support the vacuum body 8 and housing and hold them in close proximity to the filter 3.

An adjustment means (not shown) is optionally provided so as to enable the gap between the brush 2 and the front face of the filter 3 to be adjusted in order to achieve optimal spacing. That is so that they are sufficiently spaced apart to permit free travel of the brush 2, but close enough to ensure the brush 2 contacts the entire surface area of the filter 3 as it travels backwards and forwards.

Movement of the vacuum body 8 is driven by motor 4 attached to the vacuum body 8. The brush 2 may have a straight edge but is preferably of the type that rotates as it passes across the filter 3. The motor 4 drive may be arranged to drive this rotational movement as well as the side-to-side movement (left-right-left) movement of the brush 2. The brush 2 is ideally mounted in the vacuum body 8 on a drive shaft (not shown) that forms an axis of rotation and has a flexible and lightweight hose or conduit 5 connected to it so as to receive dislodged dirt and dust from the filter 3.

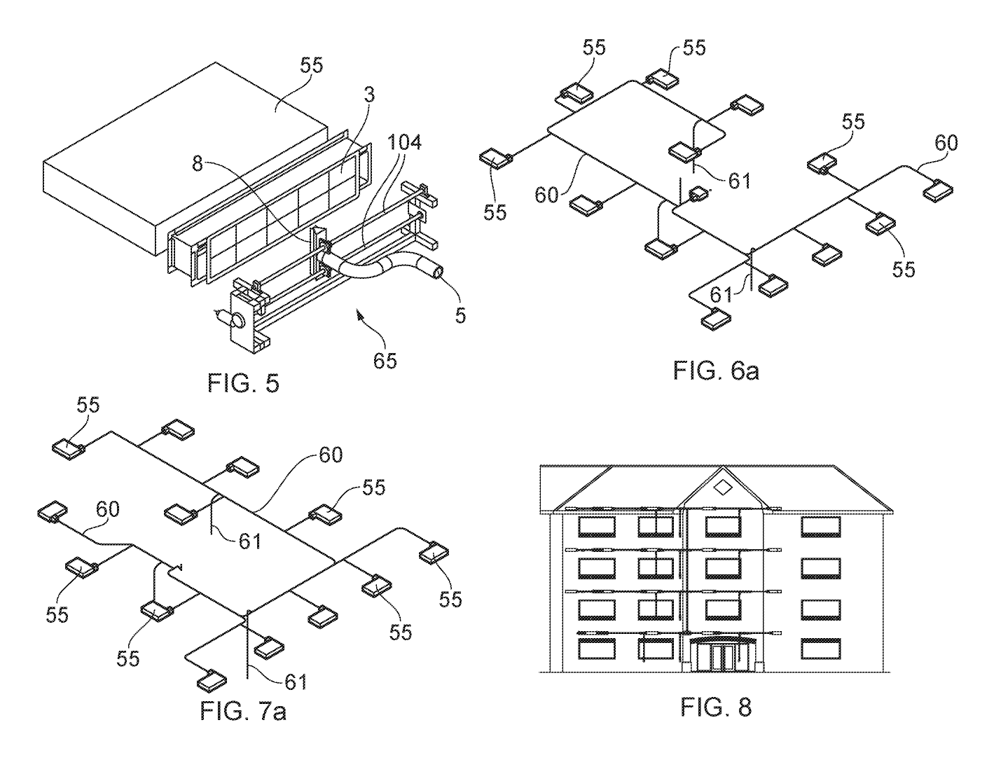

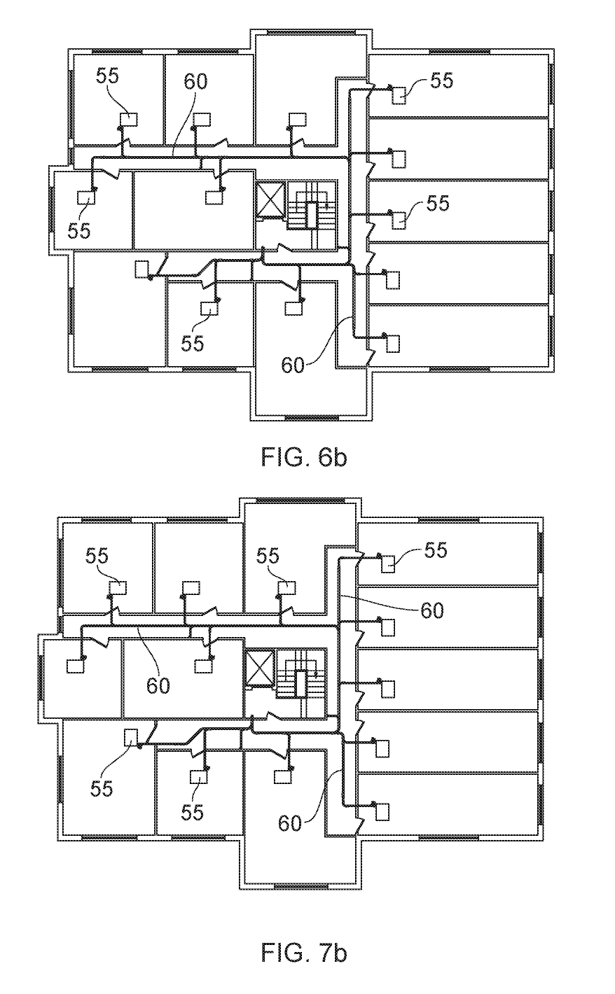

Referring to FIGS. 3a, 3b and 3c conduit 5 connects to the vacuum body 8. One end of the conduit 5 connects to the vacuum body 8 at the top on an inner side. The other or outer end of the conduit 5 is connected in use to a vacuum source (not shown), typically via a larger conduit or network 60 (FIGS. 6a and 7a) of conduits, so that a vacuum is provided through the conduit to the vacuum body 8 and is drawn across bristles of the brush 2 as the brush passes over the filter 3. Thus ensuring that dust displaced from the filter 3 is drawn through the vacuum body 8 by the vacuum and into and along the conduit 5.

As seen in FIGS. 3a, 3b and 3c the conduit 5 is elastically extendable, stretching and retracting as the vacuum body 8 moves from side-to-side across the filter 3. It is most preferred that the conduit 5 is aligned with the direction of movement of the brush 2. The conduit 5 extends as brush 2 moves in the direction of arrow. This helps to ensure the conduit 5 extends with the brush 2 across the filter 3 and does not sag or move into an air path which might otherwise block the filter 3 in use.

The outer end of the conduit (not shown), remote from the brush 2 is configured for connection to a suction hose or outer conduit 6, which in use provides a pathway to a remote pump, fan, blower or exhauster that provides the vacuum. The suction hose 6 in turn leads to a main collection receptacle (not shown) from where dust from each filter 3 is collected for disposal.

The air conditioning filter cleaner can be fitted during construction, or it can be retrofitted to an existing system. An air conditioning system comprises a plurality of ducts and associated filters. Each of these is fitted with a filter cleaner 1, the filter cleaners fluidically connected via the suction hoses 6, a central vacuum system providing a suction force to the filter cleaners 1. A plurality of solenoid valves (not shown) are located in the hoses 6 and are selectively activated to close or open pathways within the hoses to direct suction force to one or more of the filter cleaners 1. This allows the air filter cleaners to be selectively or sequentially activated to help direct the vacuum with necessary force. Dust cleaned from the filters 3 is directed to a central collection unit for disposal. This central collection point can include HEPA filtration.

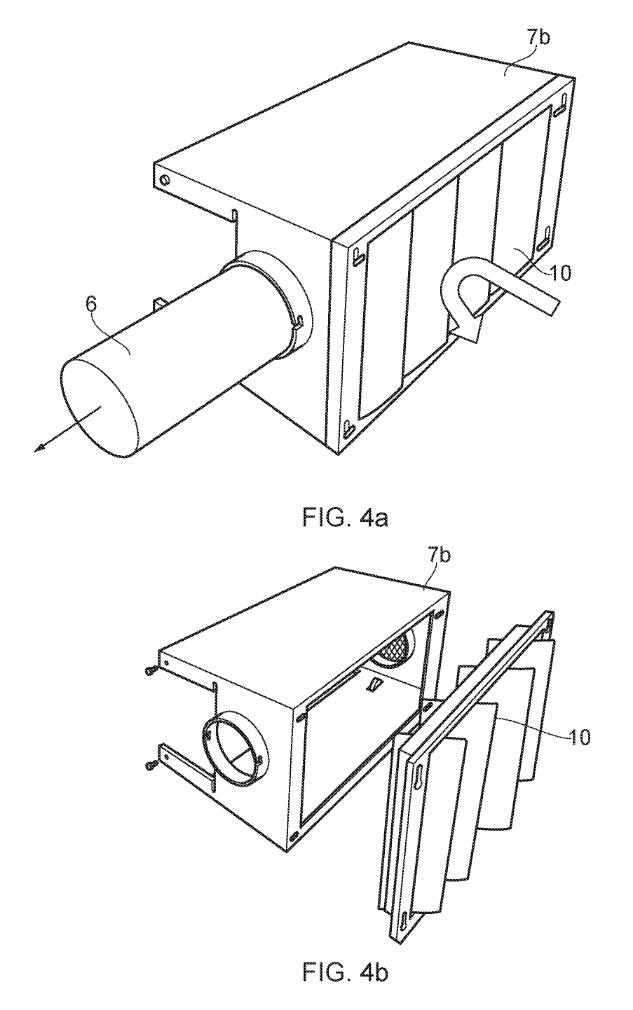

An alternative embodiment of air conditioning filter cleaner is shown in FIGS. 4a and 4b. In this embodiment, the front fascia 7b has an associated filter closing shutter array 10 configured to close across the filter to prevent air flow therethrough when activated or whilst being cleaned in order to stop dust falling into an office or room. The shutter array is open in use for normal operation of the air conditioning.

A vibration mechanism is connected to the front fascia 7, the vibration mechanism comprising a cam 11, configured to be driven by a motor or similar and rotate within the front fascia 7, eccentrically against the filter housing and therefore the filter, to cause them to vibrate. The front fascia shown in FIG. 2 has an aperture at the side for connection to a vacuum source such as the suction hose 6, to provide a suction force through the conduit and remove dust shaken free by the vibration caused by rotation of the cam.

Referring to FIGS. 5, 6, 7 and 8, there is shown a system which is installed in a building (FIG. 8) on the ground and first floors. The diagrammatical overview of air conditioning units 55, ducts 60 and air filter cleaners 65 is depicted in FIGS. 6a and 7a. These are air conditioning filter cleaners installed on the ground and first floors shown in FIGS. 6b and 7b respectively. Down pipes (not shown) interconnect conduits on each floor and provide a connection to a main fan, or blower (not shown) which draws air to form a partial vacuum and as a result of which dust and dirt is drawn along the conduit network.

Suitable ports (not shown) may be provided in offices or corridors within a building. These serve to close off branch conduits 61 which permit cleaning personnel to insert a specialised plug or hose into a port or connection point (not shown) at the end of conduits 61. This feature enables a cleaning attachment or vacuum cleaner head to be connected to the main network 60, which is under a partial vacuum, thereby enabling local cleaning of offices and walkways to be carried out. An advantage of this feature is that shops and offices do not require expensive vacuum cleaners which may be expensive or heavy or cumbersome. This feature of the system requires a cleaner merely has to carry a relatively light weight handheld cleaning attachment (not shown).

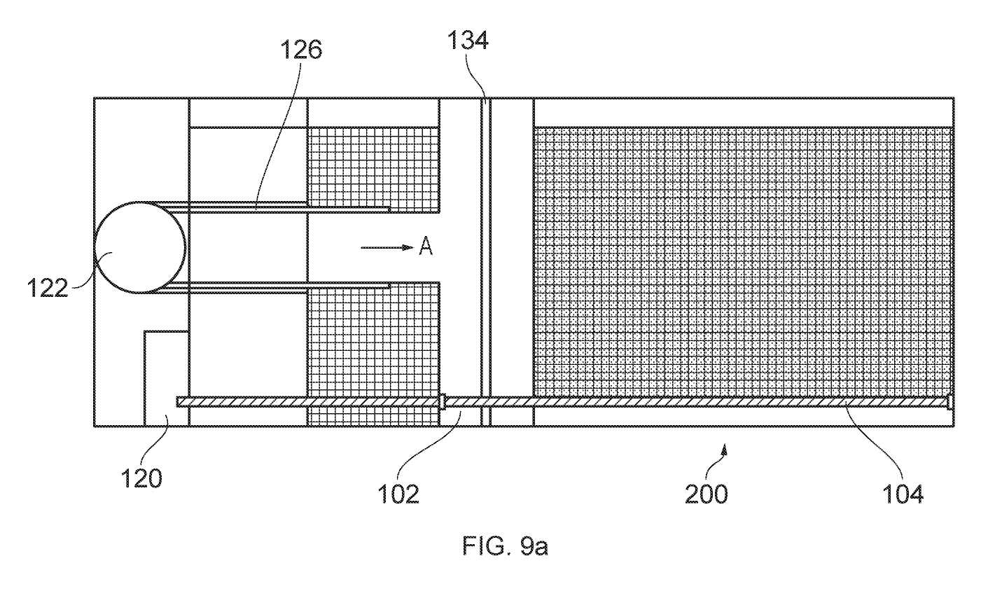

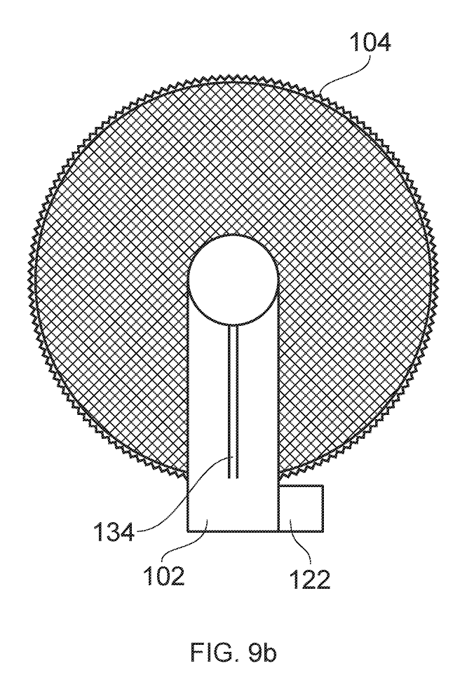

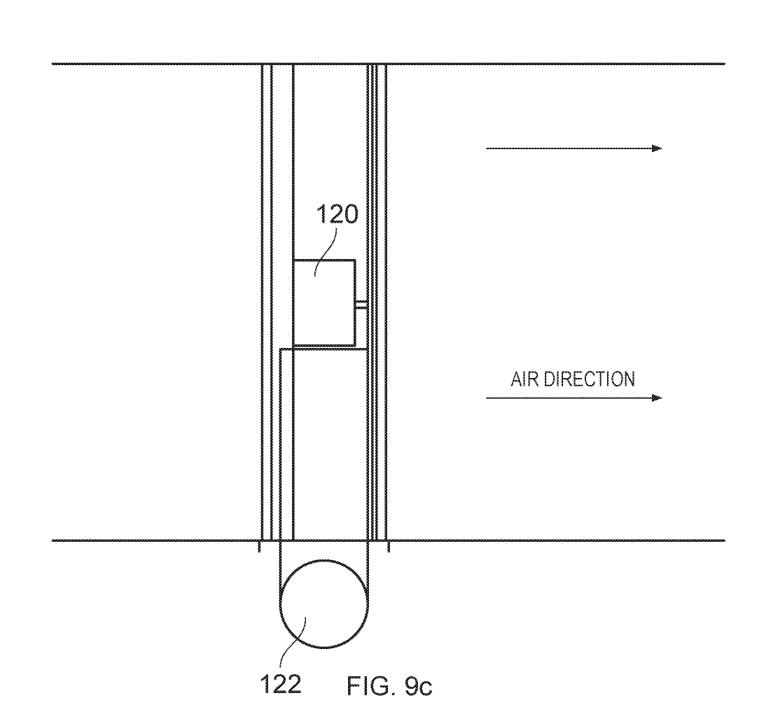

Referring now to FIGS. 9a, 9b and 9c there are shown two further embodiments of an air filter cleaning system. The air filter cleaner 100 shown in FIGS. 9a and 9b includes a cleaning head 102 which is mounted on a threaded rail or guide 104 and which translates forwards and backwards under the control of an air supply from the main fan or pump (not shown) and which acts to draw the cleaning head 102 in the direction of arrow A-A′. The diagrammatical view in FIG. 9b illustrates a side elevation view of the arrangement shown in FIG. 9a and shows in detail motor drive 120 and solenoid valve 122.

Threaded drive 124 supports the cleaning head 102 which is connected to the vacuum supply by way of a telescopic vacuum tube 126. Cleaning head 102 traverses a front panel 130 of air filter 132. Brushes 134 on the cleaning head 128 act to dislodge debris fibres and dust from front panel of the air filter 132. As is apparent from FIG. 9a, the area of filter to the right hand side of the brush 134 is darker with dust than the cleaned portion of the air filter to the left had side of the brush 134.

The embodiment shown in FIG. 9b is a plan view of an alternative cleaning system which is used for circular ducting, for example in larger buildings. Like parts bear the same reference numerals in FIGS. 9a, 9b and 9c. The direction of air flow through the ducting is through the filter 3 past the brush. The motor 120 and vacuum ducting remain relatively stationery, for example in the vertical position as shown in the orientation in FIG. 9b. The circular filter panel shown in FIG. 9b has a toothed periphery which engages with a gear on a motor drive 202. The motor turns and rotates the filter in a guide so that brushes dislodge dirt and dust from the surface of the air filter. The direction of travel of the air filter is shown by the clockwise arrow B.

The invention has been described by way of examples only and it will be appreciated that variation may be made to the above-mentioned embodiments without departing from the scope of invention. Firstly it will be understood that any features described in relation to any particular embodiment may be featured in combinations with other embodiments.

In an alternative embodiment a conduit is installed between the air filter cleaner and a socket, hose connection point or outlet port, ideally in a wall, for receiving a hose. Ideally the socket or outlet port is positioned in a convenient location and at a convenient height for access during or outside normal office hours, for example outside an office door or in a corridor or in a convenient position which can be accessed by a cleaner. If the socket is placed relatively high with respect to the floor in, for example a corridor, a relatively short length of conduit is sufficient to pass from it to the air conditioning filter cleaner.

A switch is ideally also located at the socket, or hose connection point (not shown) and when this is activated, for example manually or upon insertion of the hose, it switches on the motor 102 to commence a filter cleaning cycle, enabling extraction of the dust via the socket or outlet port. Local collection in a conventional vacuum clean may be performed. A switch is ideally activated upon insertion of a suitable hose or by way of a separate engagement means that initiates the cleaning head across the filter.

The benefit of the alternative embodiment is appreciated as it enables a filter to be cleaned locally by a cleaner and avoids the expense of installing conduit. Optionally a plug is fitted with a suitable cover so that only a hose is able to be received by it in order to activate the filter and to open a valve through which dust may be removed

With respect to the specification it is to be realised that the optimum dimensional relationships for the parts of the invention, to include variations in size, materials, shape, form, function and manner of operation, assembly and use, are deemed readily apparent to one skilled in the art. For example the air filter cleaner may be used with air conditioners in a building, in a vehicle, in a ship or vessel or in an aircraft.

Variation to the aforementioned embodiments may be made without departing from the scope of the invention as defined by the claims.

1-20. (canceled)

21. An air conditioning system comprises: a plurality of air conditioning filter cleaners that are connected to a network of conduits; a central vacuum system is connected to the network of conduits; and a control system is operative to control the central vacuum system and a plurality of valves in the network of conduits, the air conditioning filter cleaners include a brush and a drive means which is operable to move the brush with respect to a filter to be cleaned so as to remove dust and debris therefrom; the network of conduits is configured to define pathways for dust and debris to pass from air conditioning filter cleaners to a remote collection location where the dust and debris is collected; the control system is operative to remotely open and close at least one valve associated with a selected air conditioning filter cleaner so that a selected pathway is defined in the network of conduits from the selected air conditioning filter cleaner to the remote collection location; and the control system is operative to actuate the selected air conditioning filter cleaner associated with the selected pathway, so that a suction force provided by the central vacuum system is directed through the selected pathway and directs dust and debris removed by the brush of the selected air conditioning filter cleaner, via the selected pathway, to the remote location where dust and debris is collected.

22. A system according to claim 21 wherein a clamping means is configured to connect at least one air filter cleaner to a filter housing.

23. A system according to claim 22 wherein the clamping means has a front fascia that extends and overlaps with an air filter when connected to a filter housing.

24. A system according to claim 23 wherein a fascia forms a surrounding frame for the air filter.

25. A system according to claim 21 wherein at least one of the drive means is an electric motor.

26. A system according to claim 21 wherein at least one of the brushes is sized and arranged to pass across an air filter in a direction substantially perpendicular to a longitudinal axis of the air filter.

27. A system according to claim 21 wherein at least one elastically extendable conduit connects a filter cleaner to the network of conduits.

28. A system according to claim 27 wherein the elastically extendable conduit is aligned with the direction of movement of the brush, the elastically extendable conduit extends and retracts as the brush moves with respect to the air filter.

29. A system according to claim 28 wherein the elastically extendable conduit is positioned adjacent to an edge of the air filter.

30. A system according to claim 21 wherein the air conditioning filter cleaners are located in at least one of the group comprising: a building, a vehicle, a ship, a vessel and an aircraft.

31. A system according to claim 21 which includes a vibration means configured to vibrate at least one air filter to assist in dislodging dust and debris therefrom.

32. A system as claimed in claim 31 wherein the vibrating means comprises a cam, configured to rotate and to cause the filter to vibrate.

33. A system according to claim 21 wherein at least one filter cleaner includes a sensor that senses the amount of dust that is present and/or the state of an air filter before and after cleaning.

34. A system according to claim 21 includes at least one moveable shutter which isolates an air conditioner vent from a room during cleaning.

35. A system according to claim 21 wherein a port is provided on a branch of the network of conduits to permit insertion of a specialised plug or hose at the end of a cleaning attachment or vacuum cleaner head so as to enable cleaning to be carried out.

36. A system according to claim 21 wherein a conduit is installed between at least one air filter cleaner and a socket or outlet port provided on a wall for receiving a plug or hose at the end of a cleaning attachment or vacuum cleaner head.

37. A system according to claim 21 includes a collection unit for collecting dust at the remote collection location, wherein the collection unit has a HEPA filter.

38. A system according to claim 21 includes an air jet means to assist in dislodging dust and debris from the filter.

39. A system according to claim 21 wherein a valve is selectively switched on and off by an electrically controlled servo device or solenoid valve.
